(19) United States
(12) Patent Application Publication
(10) Pub. No.: US 2009/0033500 A1
(43) Pub. Date: Feb. 5, 2009

(54) METHODS AND APPARATUS FOR LOCATIONING EMERGENCY PERSONNEL USING RFID TAGS DEPLOYED AT A SITE

(75) Inventors: Ajay MALIK, Santa Clara, CA (US); Shilpa Moghe, San Jose, CA (US); Ranjith Ravi, San Jose, CA (US); Asa Yanai, Hartsdale, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 11/831,739

(22) Filed: Jul. 31, 2007

(51) Int. Cl. G08B 13/14

(52) U.S. Cl. 340/572.8; 340/572.1

(57) ABSTRACT

Systems and methods are provided for determining the location of an individual (e.g., emergency personnel) within an environment having a plurality of RFID tags located therein. A system includes a wearable RFID reader removeably attached to the individual (e.g., on his/her wrist, or uniform), wherein the wearable RFID reader is configured to activate and receive data from a plurality of RFID tags located (e.g., previously deployed) therein. An access port is positioned external to the environment and is configured to receive the data from the wearable RFID reader. A locationing module is communicatively coupled to the access port and is configured to determine the location of the individual within the site based on the data acquired from the at least one RFID tags.

### TECHNICAL FIELD

The present invention relates generally to radio frequency identification (RFID) systems, wireless local area networks (WLANs), and other such networks incorporating RF tags, and, more particularly, to methods of determining the location of emergency personnel such as firemen, policemen, and the like within an building or other site.

### BACKGROUND

In many instances it is desirable to know the location of an individual or individuals within a building or other such site. This is particularly the case with emergency response personnel such as policemen, firemen and the like, as these individuals are often operating in the context of dangerous conditions such as fires, floods, or other conditions where knowledge of the individual's position would help coordinate efforts to resolve the emergency. While it is common for such personnel to utilize radios and other communication equipment in emergencies, due to the exigencies of an actual emergency, the information transmitted by emergency personnel can be intermittent and/or inaccurate.

In recent years, Radio frequency identification (RFID) systems have achieved wide popularity in a number of applications, as they provide a cost-effective way to track the location of a large number of assets in real time. In large-scale application such as warehouses, retail spaces, and the like, many types of tags may exist in the environment (or “site”). Likewise, multiple types of readers, such as RFID readers, active tag readers, 802.11 tag readers, Zigbee tag readers, etc., are typically distributed throughout the space in the form of entryway readers, conveyer-belt readers, mobile readers, etc., and may be linked by network controller switches and the like.

While it is common for RFID tags to be distributed throughout a commercial space to track assets, the tags are not been deployed in a way that would assist in tracking individuals within the environment as would be required by emergency personnel. Furthermore, emergency personnel are not equipped to read such tags and process the information in a way that would assist them in any meaningful manner.

Accordingly, it is desirable to provide improved methods and systems for determining the location of firemen, policemen, and other emergency personnel in environments where multiple tags have been deployed. Furthermore, other desirable features and characteristics of the present invention will become apparent from the subsequent detailed description and the appended claims, taken in conjunction with the accompanying drawings and the foregoing technical field and background.

### BRIEF SUMMARY

The present invention provides systems and methods for determining the location of an individual (e.g., emergency personnel) within a site having a plurality of RFID tags located therein. One embodiment of the method includes providing the individual with a wearable RFID reader, activating at least one of the RFID tags via the wearable RFID reader when the individual is within range of the reader, and receiving, via the wearable RFID reader, data acquired from the at least one RFID tags. The method further includes transmitting the data to a wireless access port (AP) external to the environment; and determining the location of the individual within the environment based on the data acquired from the at least one RFID tags.

A system in accordance with one embodiment includes a wearable RFID reader removeably attached to the individual (e.g., on his/her wrist, or uniform), wherein the wearable RFID reader is configured to activate and receive data from the plurality of RFID tags. An access port is positioned external to the site and is configured to receive the data from the wearable RFID reader. A locationing module is communicatively coupled to the access port and is configured to determine the location of the individual within the site based on the data acquired from the at least one RFID tags.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a system in accordance with an exemplary embodiment of the present invention.

### DETAILED DESCRIPTION

The following detailed description is merely exemplary in nature and is not intended to limit the range of possible embodiments and applications. Furthermore, there is no intention to be bound by any theory presented in the preceding background or the following detailed description.

For simplicity and clarity of illustration, the drawing figures depict the general structure and/or manner of construction of the various embodiments. Descriptions and details of well-known features and techniques may be omitted to avoid unnecessarily obscuring other features. Elements in the drawings figures are not necessarily drawn to scale: the dimensions of some features may be exaggerated relative to other elements to assist improve understanding of the example embodiments.

Terms of enumeration such as “first,” “second,” “third,” and the like may be used for distinguishing between similar elements and not necessarily for describing a particular spatial or chronological order. These terms, so used, are interchangeable under appropriate circumstances. The embodiments of the invention described herein are, for example, capable of use in sequences other than those illustrated or otherwise described herein. Unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

The terms “comprise,” “include,” “have” and any variations thereof are used synonymously to denote non-exclusive inclusion. The terms “left,” right,” “in,” “out,” “front,” “back,” “up,” “down,” and other such directional terms are used to describe relative positions, not necessarily absolute positions in space. The term “exemplary” is used in the sense of “example,” rather than “ideal.”

For the sake of brevity, conventional techniques related to signal processing, data transmission, signaling, network control, the 802.11 family of specifications, wireless networks, RFID systems and specifications, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

The present invention generally relates to systems and methods for locating emergency personnel such as firemen, policemen, and the like in a building or other site where RFID tags have previously been deployed.

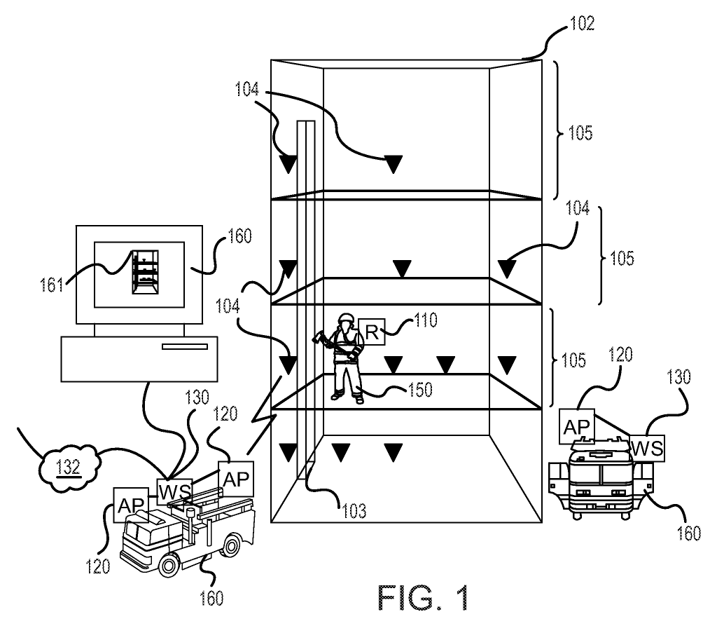

Referring now to FIG. 1, an example environment useful in describing the present invention generally includes a building or other site 102 (alternatively referred to as an “environment”), emergency personnel 150, and associated vehicles 160. In this example, the vehicles 160 (e.g., fire trucks, etc.) and personnel 150 have responded to an alarm or other request at site 102. Vehicles 160 are located external to site 102, while personnel 150 moves through site 102, examining the environment and addressing any emergency concerns as appropriate. Note that while a three-dimensional, multi-floored building is illustrated in FIG. 1, the invention is not so limited. Site 102 may be any two-dimensional or three-dimensional space with or without buildings and other structures. Example sites include, for example, single-story buildings, school campuses, high-rise buildings, commercial buildings, etc.

A number of RF tags (“RFID tags,” or simply “tags”) 104 are distributed throughout the environment. In general, these tags 104 are preferably pre-deployed throughout the site 102, e.g., during or after construction of the building, but prior to arrival of personnel 150 in connection with the event illustrated in FIG. 1.

In general, as described in further detail below, personnel 150, while moving through site 102, carries a wearable RFID reader 110 that suitably activates any nearby tags 104 and sends the relevant tag data to one or more access ports (APs) 120 and wireless switches 130 located on vehicles 160. Various software and hardware (e.g., computer 160, etc.) produce a display 161 indicative of the position of personnel 150 within site 102.

Tags 104 may be positioned throughout site 102 with a density and number that is appropriate given the power of the tags as well as structural details (e.g., internal architecture) of site 102. That is, tags 104 may be distributed evenly throughout the site, or may be clustered in predefined “zones.” In the illustrated embodiment, for example, zones 105 are defined for each floor 105, as well as for elevator bank 103. As shown, multiple tags 104 are included in each zone. In general, each zone preferably has at least one such tag 104, but may have any number, depending upon the size of the zone and other such factors.

Tags 104, which may be of various types, are read by wearable RFID reader 110 when personnel 150 is within range, as is known in the art. Thus, these tags may be referred to as “near-me” tags, in that they activate when personnel 150 is near them, and the transmitted tag data can be used to determine his/her approximate location.

Note that the term “RFID” is not meant to limit the invention to any particular type of tag. The term “tag” refers, in general, to any RF element that can be communicated with and has an ID (or “ID signal”) that can be read by another component. In general, RFID tags (sometimes referred to as “transponders”) may be classified as either active, passive, or semi-active. Active tags are devices that incorporate some form of power source (e.g., batteries, capacitors, or the like) and are typically always “on,” while passive tags are tags that are exclusively energized via an RF energy source received from a nearby antenna. Semi-active tags are tags with their own power source, but which are in a standby or inactive mode until they receive a signal from an external RFID reader, whereupon they “wake up” and operate for a time just as though they were active tags. While active tags are more powerful, and exhibit a greater range than passive tags, they also have a shorter lifetime and are significantly more expensive. Such tags are well known in the art, and need not be described in detail herein.

RFID reader 110 may be worn by personnel 110 in any suitable manner. In one embodiment, reader 110 is removeably attached to the body of personnel 110—e.g., a wristband, a necklace, or the like. In another embodiment, reader 110 is incorporated directly into the clothing or uniform of personnel 110—e.g., within a pocket, hat, etc. worn by personnel 110.

RFID reader 110 may have multiple associated antennas, and may incorporate additional functionality, such as filtering, cyclic-redundancy checks (CRC), and tag writing, as is known in the art. Each antenna within reader 110 has an associated RF range (or “read point”), which depends upon, among other things, the strength of the respective antenna. The read point corresponds to the area around the antenna in which a tag 104 may be read by that antenna, and may be defined by a variety of shapes, depending upon the nature of the antenna. It is not uncommon for RF ranges or read points to overlap in real-world applications (e.g., doorways, small rooms, etc.).

Within vehicle 160, switching device 130 (alternatively referred to as an “RF switch,” “WS,” or simply “switch”) may be coupled to a network 132 (e.g., a WiFi network coupled to one or more other networks or devices) and communicates with one or more software applications (not shown). Wireless access ports 120 (alternatively referred to as “access ports” or “APs”) are configured to wirelessly communicate with reader 110. APs 120 suitably communicate with switch 110 via appropriate communication lines (e.g., conventional Ethernet lines, or the like). Any number of additional and/or intervening switches, routers, servers and other network components may also be present in the system.

A particular AP 120 may communicate with multiple readers 110 (e.g., when multiple personnel 150 are located within site 102). One or more APs 120 may be coupled to a single switch 110, as illustrated, and may be distributed in any advantageous manner internal to or external to vehicle 160. For example, in the case of a ladder truck, it is possible to deploy one AP 120 near the cab of the vehicle, and a second AP 120 at the end of the ladder, which might be advantageous in situations where the ladder is extended upward in a rescue scenario. In general, RF Switch 110 determines the destination of packets it receives and routes those packets to the appropriate AP 120 Thus, each AP 120 acts primarily as a conduit, sending/receiving RF transmissions via MUs 130, and sending/receiving packets via a network protocol with WS 110.

WS 130 may support any number of tags that use wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. As described in further detail below, switch 102 includes hardware, software, and/or firmware capable of carrying out the functions described herein. Thus, switch 102 may comprise one or more processors accompanied by storage units, displays, input/output devices, an operating system, database management software, networking software, and the like. Such systems are well known in the art, and need not be described in detail. Switch 102 may be configured as a general purpose computer, a network switch, or any other such network host. In a preferred embodiment, controller 102 is modeled on a network switch architecture but includes RF network controller software (or “module”) whose capabilities include, among other things, the ability to allow configure and monitor readers 108 and antennas 106.

Locationing of personnel 150 generally involves examining all of the RFID tag data available at a particular time and then using rules and a locationing algorithm to determine the most likely location of the tags associated with the tag data. In accordance with one embodiment, the system is configured to reconcile the location of personnel 150 based on a pre-defined floor map (i.e., a map of the location of RFID readers) and or a zone map, and produce a graphical representation 161 indicating the position of personnel 150 within site 102. This information may be transmitted to a base station (e.g., control center, etc.) through network 132. Any such map and zone information may be preloaded in vehicle 160, downloaded over network 132, or received from site 102 upon arrival. Stated another way, the IDs for each tag 104, and their respective locations, are preferably known prior to beginning the locationing process; however, this knowledge may be distributed over a number of systems and networks. In a particular embodiment, RFID tag placement is predefined, and nomenclature related to that placement is embedded within the tag so that a quick understanding of the floor and/or zone can be determined without the use of building drawings.

It should be appreciated that the example embodiment or embodiments described herein are not intended to limit the scope, applicability, or configuration of the invention in any way. For example, these methods may be used in connection with standard barcode readers and the like. In general, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for determining the location of an individual within a site having a plurality of RFID tags located therein, comprising:
providing the individual with a wearable RFID reader;
activating at least one of the plurality of RFID tags via the wearable RFID reader;
receiving, via the wearable RFID reader, data acquired from the at least one RFID tags;
transmitting the data to a wireless access port external to the site; and
determining the location of the individual within the site based on the data acquired from the at least one RFID tags.

2. The method of claim 1, wherein providing the individual with a wearable RFID reader includes providing a wearable RFID reader configured to read active and passive tags.

3. The method of claim 1, wherein receiving data acquired from the at least one RFID tags includes receiving predetermined location information associated with the tags.

4. The method of claim 1, wherein transmitting the data to a wireless access port includes transmitting the data to a vehicle located external to the site.

5. The method of claim 4, wherein determining the location includes determining the location utilizing a locationing module located on the vehicle and in communication with the access ports.

6. The method of claim 1, further including providing a display configured to provide a graphical representation of the location of the individual within the site.

7. The method of claim 1, further including transmitting the data to a central office communicatively coupled to a wireless switch that is communicatively coupled to the access ports.

8. A system for determining the location of an individual within an site having a plurality of RFID tags located therein, comprising:
a wearable RFID reader removeably attached to the individual, the wearable RFID reader configured to activate and receive data from the at least one of the plurality of RFID tags;
an access port external to the site, the access port configured to receive the data from the wearable RFID reader; and
a locationing module communicatively coupled to the access port, the locationing module configured to determine the location of the individual within the site based on the data acquired from the at least one RFID tags.

9. The system of claim 8, wherein the RFID tags are “near me” tags that receive power and are activated by the wearable RFID reader.

10. The system of claim 8, wherein the data acquired from the at least one RFID tags includes predetermined location information associated with the tags.

11. The system of claim 8, wherein the wireless access port is located within a vehicle external to the site.

12. The system of claim 11, wherein the vehicle is an emergency vehicle.

13. The system of claim 12, wherein the emergency vehicle is a fire response vehicle or a police vehicle having at least two of the access ports located therein.

14. The system of claim 11, wherein the locationing module is located on the vehicle.

15. The system of claim 8, further including a display configured to provide a graphical representation of the location of the individual within the site.

16. The system of claim 8, further including a central office communicatively coupled to a wireless switch that is communicatively coupled to the access ports.

17. A wearable RFID reader system configured to activate and receive data from a plurality of RFID tags distributed throughout an site and transmit the data to a first access port located on a vehicle external to the site, wherein the data can be associated with the location of the wearable RFID reader within the site.

18. The system of claim 17, wherein the wearable RFID reader is configured to be worn on the individual's wrist or placed within a uniform worn by the individual.

19. The system of claim 17, wherein the vehicle is an emergency vehicle having a second access port.

20. The system of claim 18, wherein the vehicle is a fire response vehicle having a cab portion and a ladder portion, wherein the first access port is located adjacent the cap portion, and the second access port is located adjacent the ladder portion.
